(19) United States
(12) Patent Application Publication
(10) Pub. No.: US 2008/0294499 A1
(43) Pub. Date: Nov. 27, 2008

(54) Method and System for Managing Report on Goods Advertisement

(75) Inventors: Shin Hye Han, Gyeonggi-do (KR); Jin Hwa Lee, Gyeonggi-do (KR)

Correspondence Address: HUSCH BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 12/095,890

(22) PCT Filed: Dec. 4, 2006
(86) PCT No.: PCT/KR2006/005180

§ 371 Date: Jun. 2, 2008

(30) Foreign Application Priority Data
Dec. 5, 2005 (KR) 10-2005-0117655

(51) Int. Cl. G06Q 30/00; G06Q 10/00

(52) U.S. Cl. 705/10; 705/26; 705/14

(57) ABSTRACT

The present invention relates to a method and system for managing a report on a product advertisement which enable a relay server, which includes an advertisement service of a product sold in a shopping mall server, to collect information associated with a product sale, and which create a report page by using the collected information. The method and system for managing a report on a product advertisement collect information associated with a product sale in a relay server including an advertisement with respect to a shopping mall server under a predetermined contract, create a report page by using the collected information, and thereby analyze an advertising effect for each product more specifically.

### TECHNICAL FIELD

The present invention relates to a method and system for managing a report on a product advertisement which enable a relay server that includes an advertisement service of a product sold in a shopping mall server, to collect information associated with a product sale, and which create a report page by using the collected information.

### BACKGROUND ART

In existing Internet shopping malls, all operations, e.g. advertising products registered as selling products, selling, and delivering the advertised products, have been performed by the Internet shopping malls themselves.

Also, products are sold to only purchasers that are connected to the Internet shopping malls, and thus selling products and improving a growth in sales are somewhat limited.

To overcome the above-described disadvantages, shopping mall relay services have been operating. The shopping mall relay services enable a single server to include advertisements of the products being sold in particular Internet shopping malls, and enable purchasers to easily connect to particular Internet shopping malls. In shopping mall relay services, information about Internet shopping malls, which sell the products desired by purchasers, is provided to the purchasers. Also, the purchasers are induced to buy products by connecting to the Internet shopping mall selected by the purchasers.

After advertising or purchasing is completed, an analysis of information about particular products is essential to plan marketing strategy. The information includes a number of exposures, a number of clicks, a purchase conversion rate, a return on investment (ROI), and the like.

However, in the shopping mall relay service as well as existing Internet shopping malls, the information is maintained in only a separate device in which separate information is generated. Moreover, information management by integrating the information is not even attempted. That is, usage of the information is low. For example, in the shopping mall relay service, although products are actually purchased in a particular Internet shopping mall by the purchasers that are connected by a relay server, the relay server may not obtain information associated with the purchase. In the example described above, complex operations, e.g. connecting to the Internet shopping mall and requesting for the information, are required so that the relay server may obtain the information generated in the Internet shopping mall server.

Accordingly, relay servers may not obtain information generated in Internet shopping mall servers which directly handle products. Also, relay servers may not systematically measure advertising effects of advertised products.

Thus, a new information management model, which may analyze advertising effects for each product more specifically by integrally reporting information generated in association with product sales, is required.

### DISCLOSURE OF INVENTION

### Technical Goals

The present invention provides a method and system for managing a report on a product advertisement which collect information associated with a product sale in a relay server that includes an advertisement service with respect to a shopping mall server under a predetermined contract, create a report page by using the collected information, and thereby may analyze an advertising effect for each product more specifically.

The present invention also provides a method and system for managing a report on a product advertisement which may easily enable a relay server to collect external data, which was obtained by only connecting to an existing separate shopping mall server, by including the external data in a payment script in real time without a separate access procedure.

### Technical Solutions

According to an aspect of the present invention, there is provided a method of managing a report on a product advertisement, the method including: retrieving an address of a shopping mall server in which a purchase is requested by a purchaser, in a relay server, and adding a mall identification parameter to the retrieved address; connecting the purchaser to the shopping mall server by using the retrieved address in the relay server; selling a predetermined product to the purchaser in response to a request for the purchase in the shopping mall server, and creating a payment script according to the selling; and loading the created payment script in the relay server, wherein the mall identification parameter includes name information and price information associated with the requested product, and the step of creating includes: searching through scripts, which are prepared in association with selling products, for a script of the product which is identified by the name information; entering a number of purchases, associated with purchase information received from the purchaser, in a purchase count record of the retrieved script; and entering a total purchase amount in a price record of the retrieved script by considering the price information and the entered number of purchases.

According to another aspect of the present invention, there is provided a system for managing a report on a product advertisement, the system including: a relay server retrieving an address of a shopping mall server in which a purchase is requested by a predetermined purchaser, adding a mall identification parameter to the retrieved address, and connecting the purchaser to the shopping mall server by using the retrieved address; and the shopping mall server selling a predetermined product to the purchaser in response to a request for the purchase, creating a payment script according to the selling, and enabling the relay server to load the payment script, wherein the mall identification parameter includes name information and price information associated with the product, and the shopping mall server creates the payment script by 1) searching through scripts, prepared in association with selling products, for a script of the product identified by the name information, 2) entering a number of purchases, associated with purchase information received from the purchaser, in a purchase count record of the retrieved script, and 3) entering a total purchase amount in a price record of the retrieved script by considering the price information and the entered number of purchases.

### BRIEF DESCRIPTION OF DRAWINGS

FIG. 1 is a diagram illustrating a network configuration of a system for managing a report on a product advertisement according to the present invention;

FIG. 2 is a diagram illustrating a configuration of a system for managing a report on a product advertisement according to an embodiment of the present invention;

FIG. 3 is a flowchart illustrating an operation of creating a payment script according to the present invention;

FIG. 4 is a diagram illustrating an example of collecting external data, generated in a shopping mall server according to a product sale, in a relay server according to the present invention; and

FIG. 5 is a flowchart illustrating a method of managing a report on a product advertisement according to an embodiment of the present invention.

### BEST MODE FOR CARRYING OUT THE INVENTION

Hereinafter, a method and system for managing a report on a product advertisement is described in detail with reference to accompanying drawings.

A ‘shopping mall server’ used in the specification refers to an online electronic commerce (e-commerce) service server which registers an advertisement of a predetermined product in a relay server. Also, the shopping mall server is an actual subject of sales, payment, and courier with respect to an ordered product, when a product is ordered by a purchaser that is connected to the relay server.

Also, the ‘relay server’ refers to an online shopping mall relay service server which integrally manages products and carries an advertisement of products on sale in a plurality of shopping mall servers under a predetermined contract. Also, the relay server induces the purchaser to be connected to a particular shopping mall server. The relay server may include a price comparison site which compares prices of a single product in the plurality of shopping mall servers and provides information about a result of the comparison.

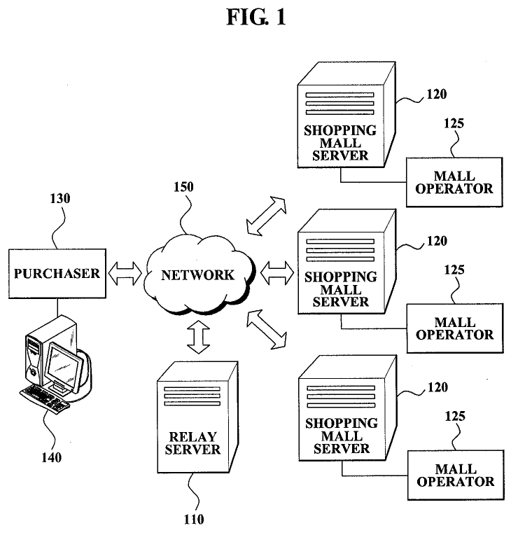

FIG. 1 is a diagram illustrating a network configuration of a system for managing a report on a product advertisement according to the present invention.

The system for managing a report on a product advertisement according to the present invention integrates information generated in association with a product sale, after the product sale is completed. Also, the system for managing a report on a product advertisement provides the information in a single scene. The information includes internal data and external data. The internal data includes a number of exposures and a number of clicks which are generated in a relay server 110 carrying an advertisement of a product. The external data includes a number of purchases, a total purchase amount, and the like, which are generated in a shopping mall server 120, i.e. a subject of the product sale.

Specifically, the system for managing a report on a product advertisement may integrally and clearly provide all information associated with the product sale, as opposed to separately providing required information in a conventional sale information management system. Accordingly, the system for managing a report on a product advertisement may provide optimal data to plan marketing strategy of the product through an analysis of the integrated information.

The relay server 110 provides product information to a purchaser 130 that desires to retrieve the product information about a particular product. In this instance, the product information may include product detail information, product price information, information about a shopping mall from which the product may be purchased, and the like. Also, the product information is created in a shopping mall server 120 under a predetermined contract. Accordingly, the relay server 110 induces an actual product purchase. Specifically, the relay server 110 arranges and provides a shopping mall server candidate group or a mall operator candidate group. In the present specification, the shopping mall server candidate group or the mall operator candidate group is referred to as a search result list. The search result list may provide the product information which is requested by the purchaser 130 in response to a product search request of the purchaser 130. Also, the relay server 110 induces the purchaser 130 to connect to a particular shopping mall server 120 according to a selection of the purchaser 130. Thus, the relay server 110 enables the purchaser 130 to approach the product information more easily.

Particularly, the search result list which is provided to the purchaser 130 may include an address, which is link information for connecting to the shopping mall server 120, and the product information. Accordingly, the purchaser 130 may connect to the shopping mall server 120 of a corresponding address by selecting, e.g. clicking with a mouse, the product information displayed in a user terminal 140 as a command input tool.

As an example, when the relay server 110 has a price comparison function, the relay server 110 first provides the purchaser 130 with information about the shopping mall server 120 with a relatively low-priced product, from the shopping mall servers 120 which sell the product requested by the purchaser 130. Also, the relay server 110 may induce the purchaser 130 to connect to the shopping mall server 120 including the product information selected by the purchaser 130.

The shopping mall server 120 corresponds to a server associated with an e-commerce site which carries an advertisement of a selling product via the relay server 110. As an example, the shopping mall server 120 actually performs an operation, e.g. selling the product to the purchaser 130 connected via the relay server 110, processing a payment according to the selling, delivering the product to the purchaser 130, and the like. Particularly, after the selling of a single product is completed, the shopping mall server 120 enables information to be loaded by the relay server 110. The information is generated while selling, processing the payment, and delivering the product. Accordingly, the information associated with the selling by the relay server 110 may be integrally managed.

Specifically, the shopping mall server 120 enables the relay server 110, which may easily service a plurality of purchasers 130, to provide the product advertisement. Also, the shopping mall server 120 may provide the purchaser 130 with the product information via the relay server 110. In this instance, the product information is generated by a mall operator 125 of the shopping mall server 120 in response to the product search request of a particular purchaser 130.

The purchaser 130 may refer to an Internet user that controls the user terminal 140 to connect to the relay server 110 and the shopping mall server 120 according to an inducement of the relay server 110. Also, the purchaser 130 may refer to an Internet user that is provided the product information about a desired product or that purchases the product online.

The mall operator 125 may refer to a shopping mall host or a product information provider. The shopping mall host operates the shopping mall server 120 in which a location on a network 150 is specified by an address. Particularly, the mall operator 125 may produce the product information about the product on sale in the shopping mall server 120, and provide the purchaser 130 with the product information via the relay server 110.

The user terminal 140 maintains a connection with the system for managing a report on a product advertisement via a network 150 such as the Internet. Also, the user terminal 140 displays the product information of each product, respectively. In this instance, the product information is generated in a separate shopping mall server 120.

Although it is not illustrated in FIG. 1, the user terminal 140 may be controlled by the purchaser 130 as well as the mall operator 125. Particularly, the user terminal 140 possessed by the mall operator 125 has a function of displaying a report page according to a report search query. Accordingly, the information associated with a product sale may be clearly provided to the mall operator 125. The report page may include the internal data and the external data. The internal data includes the number of exposures and the number of valid clicks computed in the relay server 110. The external data includes the number of purchases and the total purchase amount collected from the shopping mall server 120. Also, the report page may flexibly include other information such as a purchase conversion rate, a return on investment (ROI) which may serve as a reference when the mall operator 125 plans marketing strategy.

The system for managing a report on a product advertisement enables the relay server 110 to collect the information associated with the product sale. Also, the system for managing a report on a product advertisement may create the report page by using the collected information. Thus, according to the present invention, although a procedure for collecting the external data is not separately set when creating a report associated with the product sale, the information may be automatically collected in association with a product purchase of the purchaser 130.

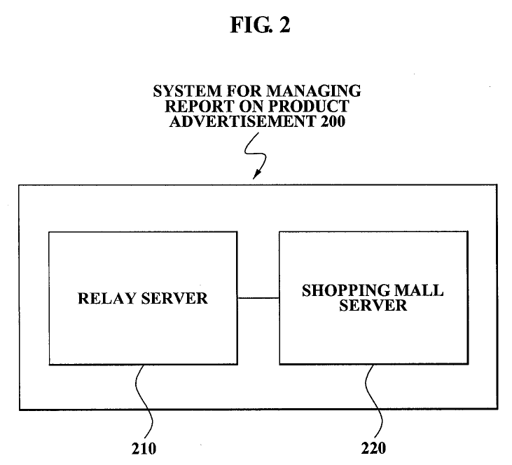

Hereinafter, the configuration of the system for managing a report on a product advertisement according to an embodiment of the present invention is described with reference to FIG. 2.

FIG. 2 is a diagram illustrating a configuration of a system for managing a report on a product advertisement 200 according to an embodiment of the present invention.

The relay server 210 retrieves an address of a shopping mall server 220 which is requested by a purchaser 130, and adds the retrieved address to a mall identification parameter. Specifically, the relay server 210 provides product information created in at least one shopping mall server 220, in response to a product search request generated by the purchaser 130. Also, the relay server 210 identifies an address of the shopping mall server 220. In this instance, the shopping mall server 220 induces the purchaser 130 to be connected according to a selection of the purchaser 130 with respect to particular product information. The particular product information is arranged on a search result list by corresponding to the address of the associated shopping mall server 220. The relay server 210 identifies an address corresponding to product information, selected by the purchaser 130, from among product information of the search result list provided to the purchaser 130. Accordingly, a network address of the shopping mall server 220, to which the purchaser 130 connects, may be recognized.

Here, the mall identification parameter is for identifying the relay server 210 which induces the purchaser 130 to connect to the shopping mall server 220. A corresponding parameter may be previously allocated to each relay server 210. As an example, ‘nv_pchs’, the mall identification parameter which is distinguished from another relay server, may be allocated to a ‘Naver shopping server’, the relay server 210. The ‘Naver shopping server’ may add the address of the shopping mall server 220, retrieved when a connection is induced by the ‘Naver shopping server’, to the ‘nv_pchs’.

Also, the mall identification parameter may include price information and name information as information about a product price and a product which is retrieved by the purchaser 130 in the relay server 210. The product price and the product, retrieved by the purchaser 130 in the relay server 210, may be identified by the mall identification parameter. Also, the purchaser 130, connected to the shopping mall server 220, may be provided with a product advertisement page with respect to the identified product or the product price.

Specifically, the relay server 210 induces the purchaser 130 to the shopping mall server 220. In this instance, the purchaser desires to obtain more detailed product information of a particular product or to purchase the product prior to a procedure of a product purchase.

Also, the relay server 210 retrieves the product information of the product corresponding to the product search request of the purchaser 130, and may arrange the retrieved product information on the search result list according to a predetermined standard. The search result list may refer to an information list provided to the purchaser 130 in response to the product search request. Also, the search result list includes the product information and the address of the shopping mall server 220 corresponding to the product information. The predetermined standard may include a cost per exposure and a cost per click. The cost per exposure is added every time the product information is arranged on the search result list. The cost per click is added every time the purchaser 130 selects the arranged product information.

The relay server 210 may calculate internal data, i.e. a number of exposures and a number of clicks of the product information, by using an operation of exposing the product information to the purchaser 130 via the search result list and an operation of clicking the arranged product information on the search result list. The relay server 210 may create a report page by using the calculated number of exposures and number of clicks.

Specifically, the relay server 210 counts a number of times the product information is exposed to the purchaser 130 requesting the product search, and thereby calculates the number of exposures. Also, the relay server 210 counts a number of times the purchaser 130 selects the exposed product information, and thereby calculates the number of clicks. Particularly, when the number of clicks is calculated, the relay server 210 may perform a validity test with respect to a generated selection. Also, the relay server 210 may be limited to only a selection which substantially connects the purchaser 130 to the shopping mall server 220. Accordingly, the relay server 210 calculates a number of valid clicks.

When the number of valid clicks is calculated, the relay server 210 sets a sufficient time to connect the purchaser 130 to a corresponding shopping mall server 220 by a selection with respect to the product information. Also, the relay server 210 determines that a selection, in which a same product is selected twice during the set time, is an invalid selection. Accordingly, the relay server 210 does not calculate the invalid click as the number of valid clicks.

As an example, a first purchase request, i.e. a request for an access to the shopping mall server 220, corresponding to a first selection with respect to the product information, is obtained. While connecting the purchaser 130 to the corresponding shopping mall server 220, the relay server 210 ignores a second purchase request, when the second purchase request is obtained by a second selection with respect to same product information. Accordingly, the relay server 210 may calculate the first selection as the number of valid clicks.

Also, the relay server 210 encodes the address which is added to the mall identification parameter. Accordingly, a security concern such as an information leakage, which may be caused while connecting the purchaser 130 to the shopping mall server 220, may be reduced. An operation of controlling a signal by using the encoded address applies with respect to the operation of the encoding described above, an operation of the connecting of the purchaser 130 to the shopping mall server 220 by using the encoded address, and an operation of decoding the address. In the present specification, the operations above are not described in detail.

The shopping mall server 220 sells the product to the purchaser 130 in response to a purchase request, and creates a payment script according to the selling. Specifically, the shopping mall server 220 provides the purchaser 130, that are connected via the relay server 210, with a product advertisement page, a product payment page, a product delivery page, and the like. Accordingly, the shopping mall server 220 enables the product sale to be performed. Also, the shopping mall server 220 enters information, generated during the product sale, in a record of a script, and thereby may create the payment script.

When the payment script is created, the shopping mall server 220 prepares a previously set script by referring to a selling product. Also, the shopping mall server 220 enters the information generated during the product sale in the record of the script associated with the sold product, and thereby may create the payment script. Here, the script may refer to a source page which is designed to easily collect the information generated during the product sale in the relay server 210. For example, the script may be previously designed by the relay server 210 for each product or regardless of any product, and be maintained in the shopping mall server 220.

Specifically, the shopping mall server 220 may create the payment script by entering the information in the record of the script. After the creating, the shopping mall server 220 stands by while loading of the payment script is performed.

The information entered in the record of the script may include external data such as a number of purchases, a total purchase amount, a purchase conversion rate, and an ROI. The relay server 210 may flexibly control a type of record, a number of records, and the like, included in the script, by considering information type to be collected.

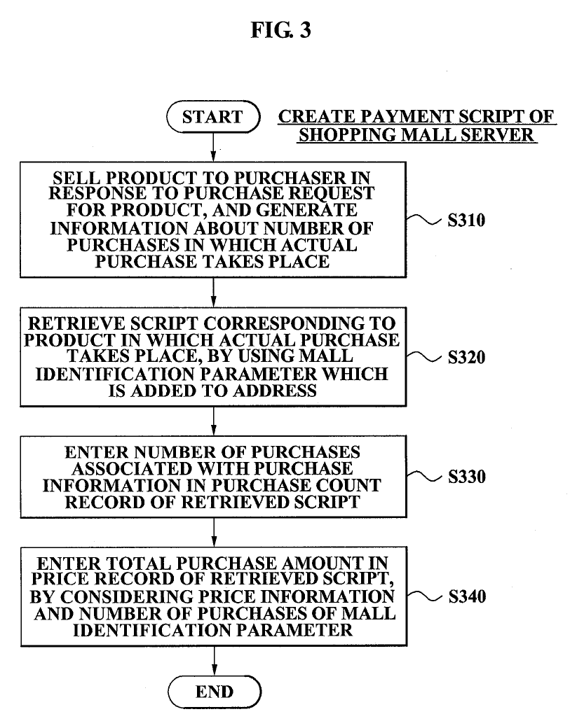

FIG. 3 is a flowchart illustrating an operation of creating a payment script according to the present invention. Hereinafter, an example of entering a number of purchases and a total purchase amount in a record of a script by a shopping mall server 220 is described with reference to FIG. 3.

In operation S310, the shopping mall server 220 sells a product associated with a purchase request, in response to the purchase request of the purchaser 130. Also, in operation S310, the shopping mall server 220 generates information about the number of purchases of the product in which an actual purchase takes place. In this instance, the product is sold to the purchaser 130 connected to the shopping mall server 220 via the relay server 210, and information associated with a payment with respect to the product is generated.

Also, in operation S320, the shopping mall server 220 retrieves a script corresponding to the product in which the actual purchase takes place, by using a mall identification parameter which is added to an address. Specifically, in operation S320, the script of the product in which the actual purchase takes place is identified from scripts prepared in association with selling products. The mall identification parameter includes name information and price information associated with the product. In this instance, the product is requested by the purchaser 130 in the relay server 210. The shopping mall server 220 may select a script of the product identified by the name information.

In the specification, as an embodiment of the present invention, it is described that the script is prepared for each product. However, when a script, which may be used with respect to all products, may be designed, operation S320 may be omitted.

In operation S330, the shopping mall server 220 enters the number of purchases associated with purchase information in a purchase count record of the retrieved script. The purchase information is received from the purchaser 130. In operation S330, the shopping mall server 220 enters a number of products in which the actual purchase takes place in the retrieved script, by using the purchase information obtained by the purchaser 130. The number of products, entered in the purchase count record, may be recognized by the relay server 210 as a number of times the product is actually sold.

In operation S340, the shopping mall server 220 enters the total purchase amount in a price record of the retrieved script, by considering the price information of the mall identification parameter and the number of purchases. In operation S340, the total purchase amount, which is paid by the purchaser 130 according to a product sale, is entered in the script. The total purchase amount may be computed by ‘price information*number of purchases’ according to a general sum method. The total purchase amount, entered in the price record, may be recognized by the relay server 210 as a total amount of the product sale in the shopping mall server 220.

Accordingly, the payment script, created by the shopping mall server 220, includes information about the number of purchases and total purchase amount which are entered in the record. External data, generated in the shopping mall server 220, may be accurately reported to the relay server 210 by loading the payment script via the relay server 210.

Also, the external data included in the payment script may include a purchase conversion rate. The shopping mall server 220 computes the purchase conversion rate by calculating a number of times the purchaser 130 connects to the shopping mall server 220 and a number of times the purchaser 130, connected to the shopping mall server 220, nearly purchases the product. The number of times the purchaser 130 connects to the shopping mall server 220 is based on a selection of the purchaser 130 with respect to a search result list provided according to a product search request. Specifically, the shopping mall server 220 computes the purchase conversion rate in association with the calculated number of times the purchaser 130 connects to the shopping mall server as a percentage, and enters the computed purchase conversion rate in a purchase conversion record of the script. Accordingly, the payment script including the external data may be created. The external data may be easily recognized by the relay server 210.

As an example, when the number of times the purchaser 130 connects to the shopping mall server 220 with respect to a particular product via the relay server 210 is ‘100 times’, and the number of times the purchaser 130 nearly purchases the product is ‘10 times’, the shopping mall server 220 may compute the purchase conversion rate of ‘10% (=(10/100)×100)’, in association with the calculated number of times.

Also, the external data included in the payment script may include an ROI. The shopping mall server 220 computes the ROI by calculating an advertising cost and a selling cost. The advertising cost is invested in association with an advertisement of the product, and the selling cost is obtained in association with a selling of the product. Specifically, the shopping mall server 220 computes the ROI as the percentage in association with the advertising cost, e.g. an amount to be paid to the relay server 210, and the selling cost. Also, the shopping mall server 220 enters the computed ROI in an ROI record of the script. Accordingly, the relay server 210 may create the payment script including the external data which may be recognized easily.

As an example, when the advertising cost which is spent in association with the particular product is ‘10,000 won’, and the selling cost which is obtained by the selling is ‘15,000 won’, the shopping mall server 220 may compute the ROI of ‘66.7% (=(10,000/15,000)×100)’ in association with the costs.

Thus, according to the present invention, the external data, which was obtained by connecting to the shopping mall server 220, is included in the payment script in real time by the relay server 210, and thereby may be easily obtained in the relay server 210 without a separate connection.

Then, the relay server 210 loads the payment script, created by the shopping mall server 220, in interoperation with the creation of the payment script. Also, the relay server 210 identifies internal data such as a number of exposures and a number of valid clicks or the external data such as the number of purchases, the total purchase amount, the purchase conversion rate, and the ROI, from the loaded payment script. Accordingly, the relay server 210 may create the report page. Specifically, the relay server 210 includes information, generated in association with the product, in the report page, and systematically manages the information. The created report page may be recorded in a predetermined database in interoperation with the shopping mall server 220 in which the product is purchased. The predetermined database refers to a storage unit controlled by the relay server 210.

Also, the relay server 210 may provide a user interface to a mall operator 125 that desires to read the report page. The relay server 210 may generate a report search query according to a keyword input with respect to the user interface of the mall operator 125. The report search query is a request signal to retrieve the previously created report page with respect to the product, which is requested by the mall operator 125, from the database. The relay server 210 retrieves the report page with respect to the particular product in response to the report search query, and provides the report page to the mall operator 125. In the specification, the keyword inputted in the user interface, i.e. a keyword, which generates the report search query, may specify a name of the retrieved product or a search duration. However, the keyword is not particularly limited in the current specification.

In the above-described example, it is described that the relay server 210 creates the report page by using a single payment script in which an actual purchase takes place. However, the relay server 210 may create the report page by using a plurality of payment scripts.

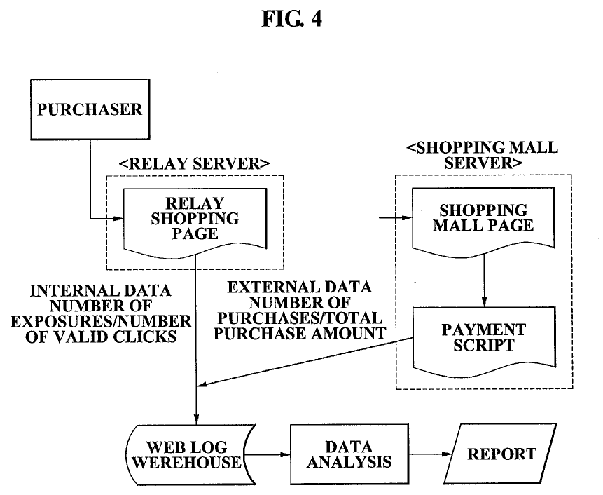

FIG. 4 is a diagram illustrating an example of collecting external data, generated in a shopping mall server according to a product sale, in a relay server according to the present invention.

In FIG. 4, it is described that a number of purchases and a total purchase amount, which are generated in the shopping mall server 220, are collected in the relay server 210 as external data.

The relay server 210 provides a purchaser 130 to be connected for a product search with a search result list with respect to a particular product. Also, the relay server 210 retrieves an address of the shopping mall server 220 associated with a selection of the purchaser 130 with respect to product information of the provided search result list. The relay server 210 adds the retrieved address, i.e. a uniform resource locator (URL), to a mall identification parameter, ‘nv_pchs’. The relay server 210 connects the purchaser 130 to the shopping mall server 220 by using the address. Accordingly, pages, associated with the product which is retrieved in the relay server 210, may be provided to the purchaser 130 by the shopping mall server 220.

As an example, the relay server 210 may add the address of the shopping mall server 220 to the mall identification parameter in a form of ‘$mall_id:$mall_pid’. When the shopping mall server 220 is related to ‘cjmall’, the relay server 210 may set the mall identification parameter as ‘mall_id:cjmall/mall_pid:1234 db’.

Also, the relay server 210 adds an address, which specifies a network location of the shopping mall server 220, to the mall identification parameter. The relay server 210 encodes the address. Accordingly, a security concern, which may be caused while connecting the purchaser 130 to the shopping mall server 220, may be actively dealt with. For example, when the mall identification parameter is ‘mall_id:cjmall/mall_pid:1234 db’, the relay server 210 may encode the address associated with ‘cjmall’, i.e. the shopping mall server 220, as an encoded value, ‘QkkNVzUwoYenKpWGt61cdA%3D%3D’.

The shopping mall server 220 to which the purchaser 130 is connected via the relay server 210, generates a cookie having a set term of validity by using the mall identification parameter, ‘nv_pchs’. The cookie has a ‘name/price’ of the product. A duration of the set term of validity is not particularly limited. For example, a cookie having a term of validity of 30 days may be generated.

The shopping mall server 220 may sell a product, which is requested through a general selling operation, to the purchaser 130. The shopping mall server 220 creates the payment script associated with the product in which an actual purchase takes place. When creating the payment script, the shopping mall server 220 may enter the number of purchases and the total purchase amount in a purchase count record and a purchase amount record of a script, respectively. The script is previously prepared by corresponding to the requested product. As an example, when two products with a price of ‘20,000 won’ are purchased, the shopping mall server 220 may create a ‘<div id=“nv_price” style=“display:none” value=“2,40000”></div>’ as the payment script.

Also, the shopping mall server 220 includes analysis information with respect to a product sale, ‘http://shopping.naver.com/CPC/purchase_analysisjs’, in the payment script. Then, the shopping mall server 220 stands by a loading of the payment script by the relay server 210.

Also, the shopping mall server 220 calls an iframe tag, ‘http://shopping.naver.com/CPC/purchase_analysis.nhn?nv_pchsp=$mall_id:$mall_pid: $price’, by using the mall identification parameter, i.e. the cookie ‘nv_pchs’ and a tag ‘nv_price’, in the ‘purchase_analysisjs’ of the script.

Table 1 below illustrates an example of a payment script created by the shopping mall server 220. In Table 1, only the number of purchases and total purchase amount are entered in the script which is previously prepared for each product.

TABLE 1

<html>
.
.
<body>
<div id=“nv_price” style=“display:none” value=“2,40000”></div>
</body>
<script language=JavaScript
src=“http://shopping.naver.com/CPC/purchase_analysis.js”>
</script>
.
.
</html>

The relay server 210 loads the payment script in real time in interoperation with the creation of the payment script. The relay server 210 adds information, which is obtained via the iframe in the loaded payment script, to time. The information includes the number of purchases and total purchase amount. The relay server 210 stores and periodically analyzes the information, and creates a report page with respect to a sold product. Accordingly, the relay server 210 may provide a mall operator 125 of the shopping mall server 220 with the information.

The relay server 210 may create the report page by collecting other external data in a similar manner described above. In this instance, the other external data includes a number of exposures, a number of valid clicks, the number of purchases, and the total purchase amount which are generated in the shopping mall server 220.

As another embodiment of the present invention, when calculating internal data, i.e. the number of exposures, and when and a product search request is generated by the purchaser 130, the relay server 210 operates a predetermined support program for counting a number of exposures, e.g. a php program. Then, when the support program for counting a number of exposures is operated, the relay server 210 extracts ‘mall_id, mall_pid information’ in response to the product search request. The ‘mall_id, mall_pid information’ is included in the search result list which is provided to the purchaser 130. Also, the relay server 210 counts the number of exposures for all product information before the search result list is displayed to the purchaser 130.

Hereinafter, a method of managing a report on a product advertisement according to an embodiment of the present invention is described in detail.

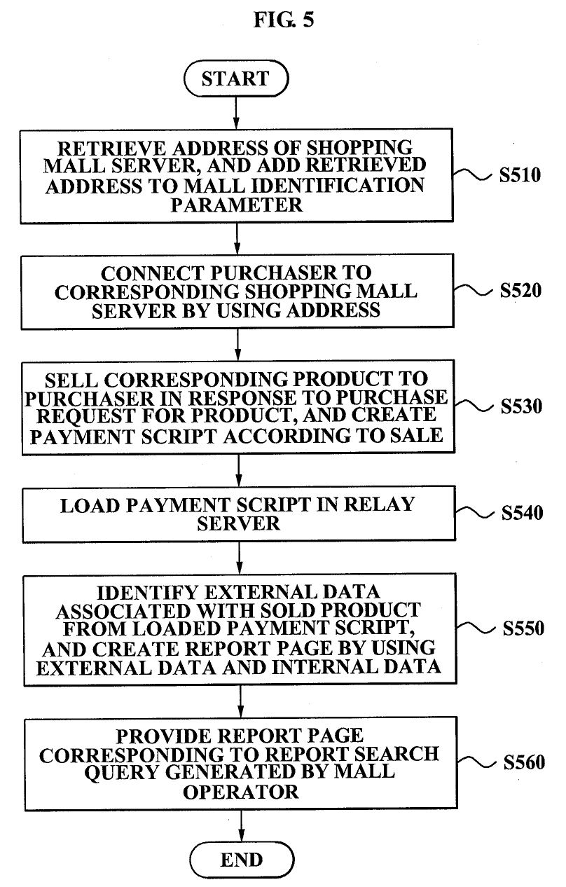

FIG. 5 is a flowchart illustrating a method of managing a report on a product advertisement according to an embodiment of the present invention.

The method of managing a report on a product advertisement according to an embodiment of the present invention is performed by a system for managing a report on a product advertisement 200 according to an embodiment of the present invention.

In operation S510, the system for managing a report on a product advertisement 200 retrieves an address of a shopping mall server 220 which is requested by a purchaser 130 in a relay server 210. Also, the system for managing a report on a product advertisement 200 adds the retrieved address to a mall identification parameter. In operation S510, the address of the shopping mall server 220, which is connected to the purchaser 130, is identified. The purchaser 130 is connected to the shopping mall server 220 according to a selection of the purchaser 130 with respect to particular product information in a search result list, provided to the purchaser 130, in response to a product search request.

Particularly, the system for managing a report on a product advertisement 200 may calculate internal data. The internal data includes a number of exposures and a number of valid clicks. The number of exposures of product information is exposed to the purchaser 130 according to the search result list. The number of valid clicks corresponds to a number of times the purchaser 130 selects the exposed product information. The calculated internal data is used when creating a report page. Information according to a product sale may be provided to a mall operator 125 or another concerned person/party.

In operation S510, the system for managing a report on a product advertisement 200 encodes the address which is added to the mall identification parameter according to a predetermined rule. Accordingly, a security concern such as an information leakage, which may occur while connecting the purchaser 130 to the shopping mall server 220, may be prevented by using the address.

In operation S520, the system for managing a report on a product advertisement 200 connects the purchaser 130 to a corresponding shopping mall server 220 by using the address. In operation S520, the product information of the search result list is selected by the purchaser 130, and thus the relay server 210 connects the purchaser 130 to the shopping mall server 220 which is specified as the address.

The mall identification parameter includes name information and price information with respect to the product information which is retrieved by the purchaser 130 in the relay server 210. The shopping mall server 220 provides the purchaser 130 with a product advertisement page, and thus a product search is maintained. The product advertisement page corresponds to the name information and price information of the mall identification parameter. Also, the product advertisement page provides more detailed product information with respect to a product which is retrieved in the relay server 210. The product advertisement page may be provided to the purchaser 130 connected to the shopping mall server 220.

In operation S530, the system for managing a report on a product advertisement 200 sells a corresponding product to the purchaser 130 in response to the purchase request for the product, and creates a payment script according to the selling. In operation S530, when an actual purchase with respect to the corresponding product takes place by the purchaser 130, the shopping mall server 220 generates information in association with a product sale in the shopping mall server 220, and creates the payment script by using the information. The information includes a number of purchases, a total purchase amount, a purchase conversion rate, and an ROI. An operation of creating the payment script has been described with reference to FIG. 3.

When creating the payment script, the payment script includes a cookie or a tag in the system for managing a report on a product advertisement 200. The relay server 210, which loads the payment script, may identify the payment script of the product, associated with the purchase request, from a plurality of payment scripts which are loaded by using the cookie or the tag.

The tag may be generated by using the price information and external data such as purchase information. The external data is generated in the shopping mall server 220, and the price information is included in the mall identification parameter.

The cookie is generated by using the price information and name information of the mall identification parameter, and may further include information about a set term of validity. The payment script may be maintained during the set term of validity in the relay server 210 or the shopping mall server 220.

In operation S540, the system for managing a report on a product advertisement 200 loads the payment script in the relay server 210. In operation S540, the payment script created in the shopping mall server 220 is loaded in real time in interoperation with the creation of the payment script.

In operation S550, the system for managing a report on a product advertisement 200 identifies the external data associated with the sold product from the loaded payment script, and creates a report page with respect to the product by using the identified external data and internal data. In operation S550, the report page for providing information in association with the product sale is created. The report page is created by using the external data and the internal data. The internal data includes the number of exposures and the number of clicks, which are generated in the relay server 210. The external data includes the number of purchases, the total purchase amount, the purchase conversion rate, and the ROI.

In operation S560, the system for managing a report on a product advertisement 200 provides a mall operator 125 of the shopping mall server 220 with a user interface to receive a report search query, and also provides the mall operator 125 with the report page corresponding to the received report search query via the user interface. In operation S560, the report page created by the relay server 210 is stored in a predetermined database, which is not illustrated, in association with the shopping mall server 220. When the mall operator 125 of the shopping mall server 220 inputs a predetermined keyword in the user interface, and the report search query is generated, a corresponding report page is extracted and provided to the mall operator 125.

According to the present invention, information about the sold product may be obtained from a single location in the report page, as opposed to a conventional information acquirement method which requires a live connection to a main server, which generates information, in order to obtain the information.

The above-described embodiment of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

### INDUSTRIAL APPLICABILITY

According to the present invention, a method and system for managing a report on a product advertisement collect information associated with a product sale in a relay server that includes an advertisement service with respect to a shopping mall server under a predetermined contract, create a report page by using the collected information, and thereby may analyze an advertising effect for each product more specifically.

Also, according to the present invention, a method and system for managing a report on a product advertisement may easily enable a relay server to collect external data, which was obtained by only connecting to an existing separate shopping mall server, by including the external data in a payment script in real time without a separate access procedure.

1-19. (canceled)

20. A method of managing a report on a product advertisement, the method comprising the steps of:
providing product information for at least one product on a website associated with a relay server, the product information being received from at least one shopping mall server;
in response to selection of a shopping mall by a user, connecting the user to the shopping mall server for purchase of a product on a website associated with the shopping mall server;
creating a payment script associated with a buy procedure for purchase of the product on the shopping mall; and
generating a report associated with the shopping mall server based on the payment script.

21. The method of claim 20, wherein the step of connecting the user to the shopping mall server comprises the steps of:
retrieving an address of the shopping mall server;
incorporating name information and price information associated with the product, in the retrieved address; and
connecting the user to the shopping mall server by using the retrieved address.

22. The method of claim 21, wherein the step of creating of the payment script comprises the steps of:
searching through scripts, prepared in association with selling products, for a script of the requested product, which is identified by the name information;
entering a number of purchases, associated with purchase information received from the user, in a purchase count record of the retrieved script; and
entering a total purchase amount in a price record of the retrieved script by considering the price information and the entered number of purchases.

23. The method of claim 20, further comprising:
receiving a report search query from a mall operator of the shopping mall server in the relay server via a user interface which is provided to the mall operator; and
retrieving the report page corresponding to the report search query, and providing the mall operator with the report page, in response to the report search query.

24. The method of claim 20, wherein the step of creating of the report page comprises the steps of:
identifying a number of purchases and a total purchase price for the purchases from the payment script, the number of purchases and the total purchase price being generated in association with the purchase request;
accumulating the identified number of purchases and total purchase price, and creating the report page by referring to the accumulated number of purchases and total purchase price; and
recording the report page in a predetermined database in association with the shopping mall server.

25. The method of claim 24, wherein the payment script comprises any one of a cookie and a tag associated with the product, and the step of identifying a number of purchases and a total purchase price identifies the payment script of the product associated with the purchase request from at least one payment script loaded by using the corresponding cookie or tag.

26. The method of claim 25, wherein the cookie is generated by using name information and price information associated with the requested product, and the tag is generated by using purchase information and the price information.

27. The method of claim 25, wherein the cookie comprises information about a set term of validity, and the payment script is stored in any one of the relay server and the shopping mall server during the term of validity.

28. The method of claim 20, further comprising the steps of:
maintaining product information for the product associated with the shopping mall server, in the relay server;
identifying the product information of the product corresponding to a product search request, which is received from the user in the relay server, and arranging the product information in a predetermined search result list;
providing the user with the search result list in response to the product search request in the relay server;
counting a number of times providing the user with the product information included in the search result list in the relay server is performed, for each of the product or the shopping mall server, and calculating a number of exposures; and
entering the calculated number of exposures in an exposure count record of the payment script in the relay server,
wherein the creating of the report page creates the report page by referring to the number of exposures.

29. The method of claim 20, further comprising the steps of:
maintaining product information for the product associated with the shopping mall server, in the relay server;
identifying the product information of a product corresponding to a product search request, which is received from the user, and arranging the product information in a predetermined search result list;
providing the user with the search result list in response to the product search request in the relay server;
connecting the user to the shopping mall server, which is associated with information about a selected product, according to a selection of the user with respect to the product information of the search result list in the relay server;
determining whether the selection is valid in the relay server;
counting the selection determined to be valid in the relay server and calculating a number of valid selections; and
entering the calculated number of valid selections in a valid selection record of the payment script in the relay server,
wherein the step of creating the report page creates the report page by referring to the number of valid selections.

30. The method of claim 29, wherein the step of determining whether the selection is valid comprises the steps of:
confirming generation of a first selection and second selection with respect to the search result list, from the user;
obtaining a first purchase request corresponding to the confirmed first selection;
obtaining a second purchase request corresponding to the confirmed second selection; and
determining the first selection as a valid selection, when the obtained first purchase request and second purchase request are generated with respect to single product information, and the second selection is generated within a predetermined period of time after the generation of the first selection.

31. The method of claim 20, further comprising the steps of:
calculating a number of connections the user has made to the shopping mall server, wherein the user has only accessed to the website associated with the shopping mall server without purchasing the product;
calculating a number of connections the user has made to the shopping mall server, wherein the user has purchased the product;
computing a transaction rate based, at least in part, upon the calculated numbers of the connections; and incorporating the transaction rate in the payment script.

32. The method of claim 20, further comprising:
calculating an advertising cost, which is invested in association with an advertisement of the product, and a selling cost, which is obtained in association with a selling of the product;
computing a return on investment (ROI) in comparison with the calculated costs as a percentage in the shopping mall server; and
entering the computed ROI in an ROI record of the payment script in the shopping mall server,
wherein the step of creating the report page creates the report page by referring to the ROI.

33. A method of managing a report on a product advertisement, the method comprising the steps of:
providing product information for a product in response to a search query received from a user, the product information including an address of at least one shopping mall server that sells the product;
calculating a number of exposures with respect to the product information;
calculating a number of connections to each of the at least one shopping mall server;
collecting information about purchases made subsequent to the connections, from each of the at least one shopping mall server, the information including a number of purchases and a total purchase price; and
generating a report associated with each of the at least one shopping mall server, the report including the calculated number of exposures, the calculated number of connections and information about purchases made subsequent to the connections.

34. The method of claim 33, further comprising:
providing a mall operator of the shopping mall server, which generates a report search query, with the report in response to the report search query.

35. One or more computer-readable media having stored thereon a computer program that, when executed by one or more processors, causes the one or more processors to perform acts including:
providing product information for at least one product on a website associated with a relay server, the product information being received from at least one shopping mall server;
in response to selection of a shopping mall by a user, connecting the user to the shopping mall server for purchase of a product on a website associated with the shopping mall server;
creating a payment script associated with a buy procedure for purchase of the product on the shopping mall; and
generating a report associated with the shopping mall server based on the payment script.

36. A system for managing a report on a product advertisement, the system comprising:
a relay server configured to provide product information for at least one product and to connect a user to a shopping mall server that sells the product; and
the shopping mall server configured to create a payment script associated with a buy procedure for purchase of the product on a website associated the shopping mall server, and wherein the relay server is further configured to generate a report associated with the shopping mall server based on the payment script.

37. The system of claim 36, wherein:
the relay server retrieves an address of the shopping mall server, incorporates name information and price information associated with the product, in the retrieved address, and connects the user to the shopping mall server by using the retrieved address, and
the shopping mall server creates the payment script by 1) searching through scripts, prepared in association with selling products, for a script of a product which is identified by the name information, 2) entering a number of purchases, associated with purchase information received from the purchaser, in a purchase count record of the retrieved script, and 3) entering a total purchase amount in a price record of the script by considering the price information and the entered number of purchases.

38. The system of claim 35, wherein the relay server identifies a number of purchases and a total purchase amount of a product which are generated in association with the purchase request, from the generated payment script, accumulates the identified number of purchases and total purchase amount with respect to the product, creates a report by referring to the accumulated number of purchases and total purchase amount, and records the report in a predetermined database in association with the shopping mall server.
